(19) United States
(12) Patent Application Publication
(10) Pub. No.: US 2015/0110678 A1
(43) Pub. Date: Apr. 23, 2015

(54) Pre-heat system for Catalysts of the Selective Catalytic Reduction Device

(71) Applicant: Robert M. Stelzer, Mississauga (CA)

(72) Inventor: Robert M. Stelzer, Mississauga (CA)

(73) Assignee: SAFETY POWER INC., Mississauga (CA)

(21) Appl. No.: 14/518,351

(22) Filed: Oct. 20, 2014

Related U.S. Application Data
(60) Provisional application No. 61/894,645, filed on Oct. 23, 2013.

(51) Int. Cl. F01N 3/28; B01D 53/94; F16L 53/00; F01N 3/20

(52) U.S. Cl. CPC F01N 3/2882; F01N 3/2006; B01D 53/94; F16L 53/002; F01N 2240/02
USPC 422/109; 137/334

(57) ABSTRACT

A pre-heat system for the catalyst of the selective catalytic reduction (SCR) device includes an air blower, an interconnecting pipe, a heater unit, and a heat supply pipe. The air blower and the heater unit are in fluid communication with each other through the interconnecting pipe while the heater unit is in fluid communication with an exhaust system through the heat supply pipe. A hot-air flow generated from the air blower and the heater unit flows into the exhaust system so that the hot-air flow is able to pre-heat the catalyst of the SCR device at or close to an activation temperature. Then the SCR device can efficiently and quickly reduce Nitrogen Oxides (NOₓ) particles of the exhaust gas.

The current application claims a priority to the U.S. Provisional Patent application Ser. No. 61/894,645 filed on Oct. 23, 2013.

### FIELD OF THE INVENTION

The present invention relates generally to exhaust gas emission control for combustion devices such as boilers, generators and internal combustion engines. More specifically, the present invention is a system that efficiently reduces Nitrogen Oxides (NOₓ) emissions of the exhaust-gas flow associated with these combustion devices.

### BACKGROUND OF THE INVENTION

Exhaust gas emission control has become particularly important due to stringent regulatory emission limits on boilers, generators and reciprocating engines. A typical exhaust gas after-treatment system may comprise many different individual emission reduction functions in order to meet the regulatory emission standards. More specifically, the selective catalytic reduction (SCR) device is frequently used in the exhaust system of combustion devices to eliminate particles of nitrogen oxides (NOₓ) in the exhaust gas. The SCR device is normally located in the exhaust system downstream of the combustion that takes place in a boiler, generator or reciprocating engine. The SCR device contains a SCR catalyst to reduce NOₓ particles in the exhaust gas as the SCR catalyst must be heated before it can be used to reduce NOₓ particles. In other words, until the SCR catalyst reaches an activation temperature, which is the minimum temperature to which the SCR catalyst must be heated, the SCR catalyst does not provide NOₓ emission reduction. Although the hot exhaust gas from the combustion in a boiler, generator or reciprocating engine heats up the SCR Catalyst, for certain applications the length of time required to heat up the SCR Catalyst using hot exhaust gas alone can be too long.

It is an object of the present invention to introduce a system to pre-heat the SCR Catalyst so that when the boiler, generator or reciprocating engine is subsequently started up, the SCR catalyst reaches its activation temperature more quickly. As a result, the

SCR device used within the application reduces NOₓ particles more quickly and efficiently compared to an application that does not utilize the pre-heat system.

### BRIEF DESCRIPTION OF THE DRAWINGS

FIG. 1 is a perspective view of the system of the present invention.

FIG. 2 is a side view of the system of the present invention, showing the area upon which a detail view is taken shown in FIG. 3.

FIG. 3 is a detail view of the SCR device taken upon area B of FIG. 2.

FIG. 4 is a basic illustration showing the electrical connection for the system of the present invention.

FIG. 5 is a basic flow chart illustrating the overall method of the present invention.

FIG. 6 is a side view of the system of the present invention, showing the air flow of the air blower and the generated hot-air flow from the heater unit.

FIG. 7 is a side view of the system of the present invention, showing the discharged unpurified exhaust-gas flow and the purified exhaust-gas flow from the SCR device.

FIG. 8 is a side view of the system of the present invention, showing the air flow of the air blower and the generated hot-air flow from the heater unit with the optional inclusion of the damper valves.

### DETAIL DESCRIPTIONS OF THE INVENTION

All illustrations of the drawings are for the purpose of describing selected versions of the present invention and are not intended to limit the scope of the present invention.

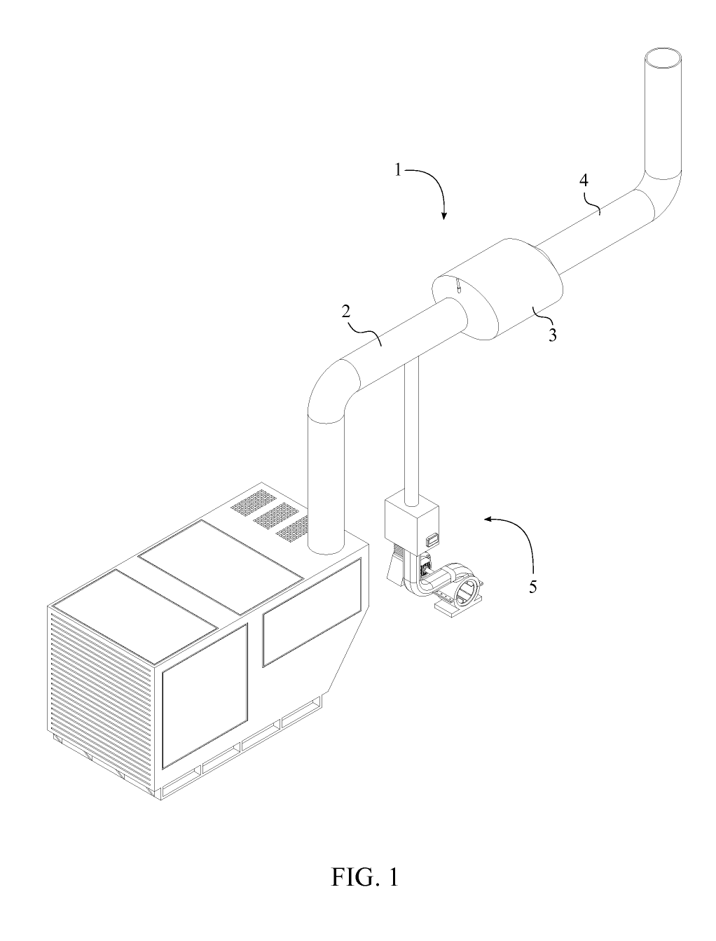

The present invention is a system for pre-heat of catalysts in a selective catalytic reduction (SCR) device 3. In reference to FIG. 1, the pre-heat system 5 is in fluid communication with an exhaust system 1 as the exhaust system 1, which generally discharges an unpurified exhaust-gas flow from a boiler, a generator, or a reciprocating engine, comprises the SCR device 3, an inlet duct 2, and an outlet duct 4. The inlet duct 2 is in fluid communication with the SCR device 3, and the outlet duct 4 is in fluid communication with the SCR device 3 opposite of the inlet duct 2 so that the SCR device 3 can function as an emission controlling device within the exhaust system 1. The SCR device 3 transforms nitrogen oxides (NOₓ) of the unpurified exhaust-gas flow into diatomic nitrogen (N₂) and water vapor with the aid of the catalyst and the reductant agent. More specifically, the reductant agent is added to the unpurified exhaust-gas flow with a reductant injector of the SCR device 3 so that the reductant agent can perform a chemical reaction with the NOₓ in order to convert the NOₓ into N₂ and water vapor.

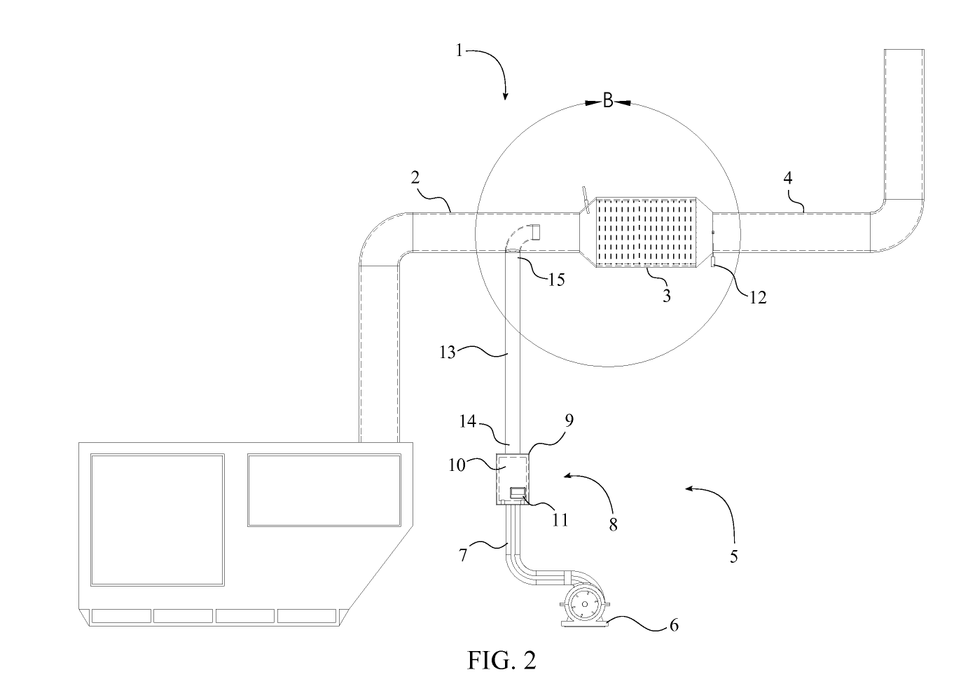

In reference to FIG. 2, the pre-heat system 5 is in fluid communication with the inlet duct 2 and positioned adjacent to the SCR device 3 so that the pre-heat system 5 is able to supply a hot-air flow to the exhaust system 1, wherein the hot-air flow is utilized within the pre-heat method of the present invention. The pre-heat system 5 comprises an air blower 6, an interconnecting pipe 7, a heater unit 8, and a heat supply pipe 13. The air blower 6 is in fluid communication with the heater unit 8 through the interconnecting pipe 7 in such a way that the interconnecting pipe 7 is positioned in between the air blower 6 and the heater unit 8. The combined functionality of the air blower 6 and the heater unit 8 generates the hot-air flow within the pre-heat system 5. More specifically, the air blower 6 generates a sufficient air flow for the pre-heat system 5 so that the air flow can be discharged into the heater unit 8 through the interconnecting pipe 7. Then the heater unit 8 is able to elevate the temperature of the air flow so that the hot-air flow can be generated within the heater unit 8.

In reference to FIG. 2, the heater unit 8 comprises a housing 9, a heating element 10, a thermostat 11, and at least one temperature sensor 12. The heating element 10, which generates thermal energy to elevate the temperature for the air flow of the air blower 6, is internally positioned with the housing 9 so that the housing 9 is able to isolate the heating element 10 from the surrounding environment. In order to facilitate in fluid communication of the interconnecting pipe 7 and heater unit 8, the interconnecting pipe 7 is traversed into the housing 9 creating a hermetic connection between the interconnecting pipe 7 and the housing 9.

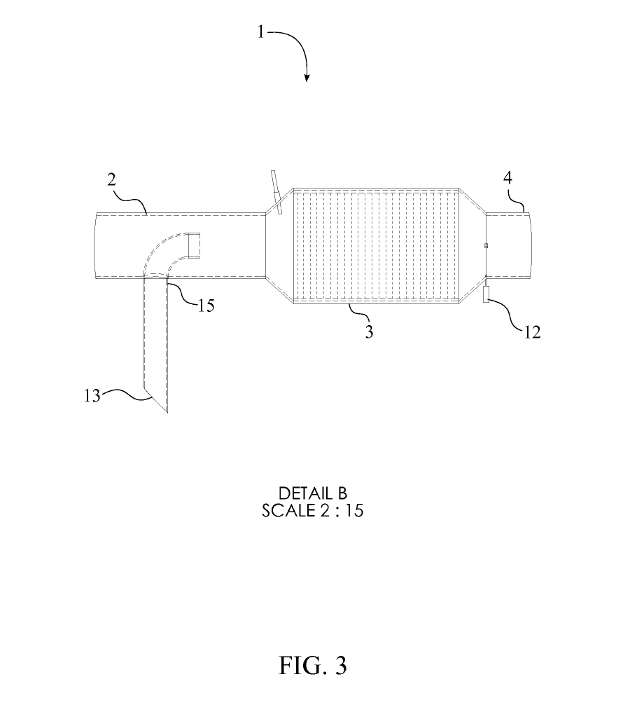

In reference to FIG. 2 and FIG. 3, the thermostat 11 that controls the functionality of the heating element 10 is externally positioned with the housing 9 so that the users can easily changes the desired temperature setting for the thermostat 11. For example, the thermostat 11 can be a physically separated device or can be implemented in software on a programmable device. Since the hot-air flow is required to enter into the SCR device 3 for the functionality of the present invention, the heater unit 8 is in fluid communication with the exhaust system 1 through the heat supply pipe 13 opposite of the air blower 6. More specifically, a first end 14 of the heat supply pipe 13 is traversed into the housing 9 while a second end 15 of the heat supply pipe 13 is in fluid communication with the inlet duct 2 and positioned adjacent to the SCR device 3. In both of the above instances, the first end 14 and the second end 15 of the heat supply pipe 13 respectively create hermetic connections between the housing 9 and the inlet duct 2. The hermetic connections of the interconnecting pipe 7 and the heat supply pipe 13 are able to maintain higher efficiency level for the pre-heat system 5 as the air flow loss and the hot-air flow loss are minimized from the pre-heat system 5.

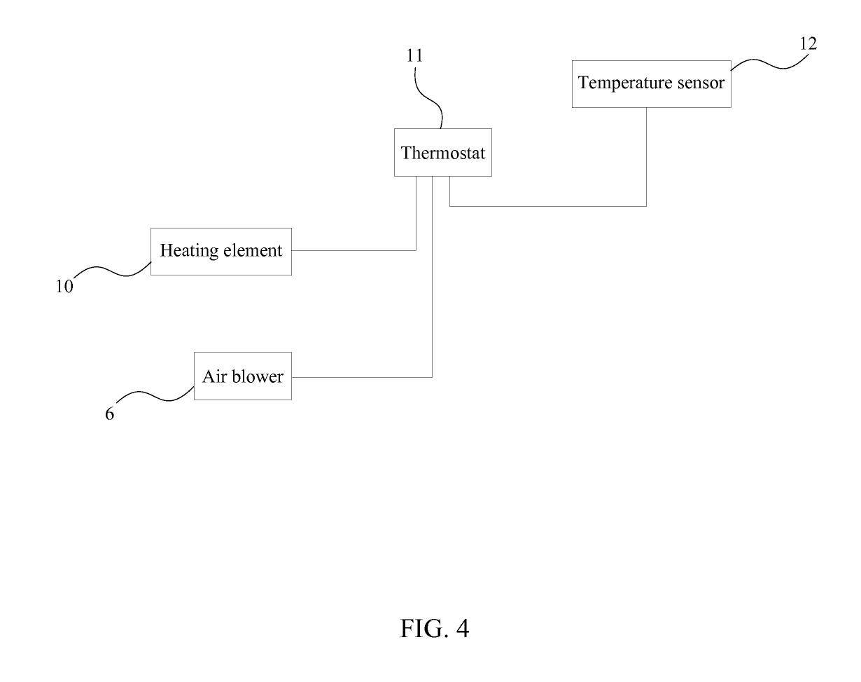

In reference to FIG. 4, the air blower 6 and the heating element 10 are electrically connected with the thermostat 11 so that the thermostat 11 is able to control the operation of the air blower 6 and the heating element 10 within the pre-heat system 5. The heating element 10 can be powered from an external power source, wherein the external power source can include, but not limited to, electric power and fossil fuel power. The at least one temperature sensor 12 is also electrically connected with the thermostat 11 as the at least one temperature sensor 12 provides temperature readings to the thermostat 11. In other words, the at least one temperature sensor 12 provides input to the thermostat 11 so that the thermostat 11 can either act as an on/off switch or can modulate the pre-heat system 5 so that the air blower 6 and the heating element 10 can be automatically activated and deactivated through the thermostat 11 and the at least one temperature sensor 12. The at least one temperature sensor 12 is traversed into the outlet duct 4 and positioned adjacent to the SCR device 3 so that the at least one temperature sensor 12 is able to measure the downstream temperature of exhaust gas flow or the hot-air flow of the exhaust system 1.

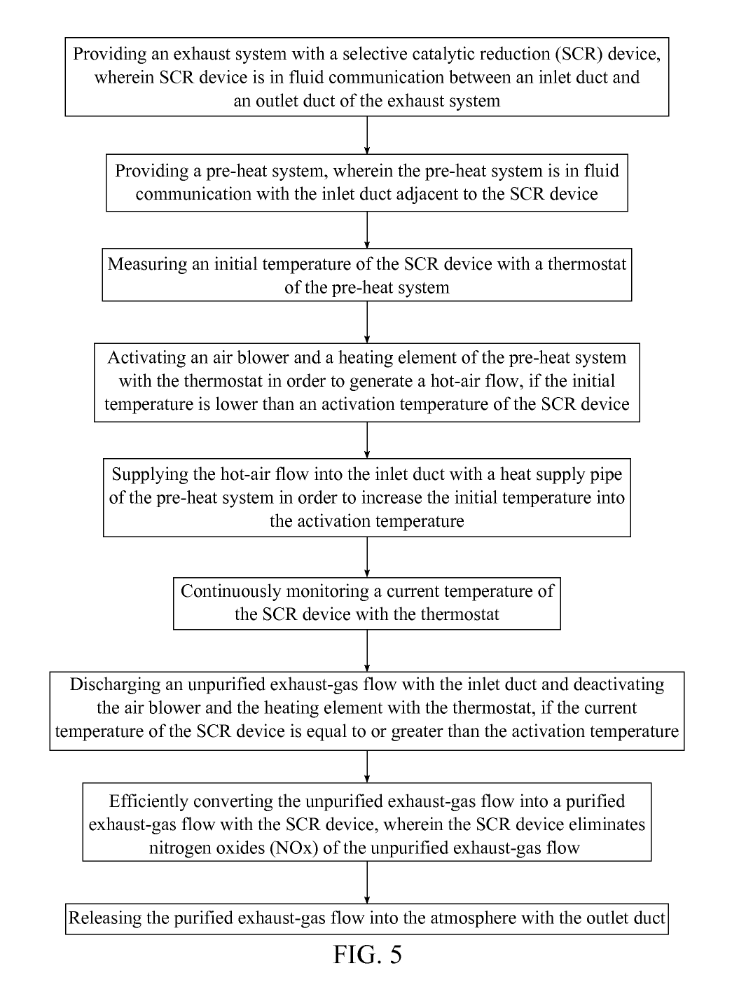

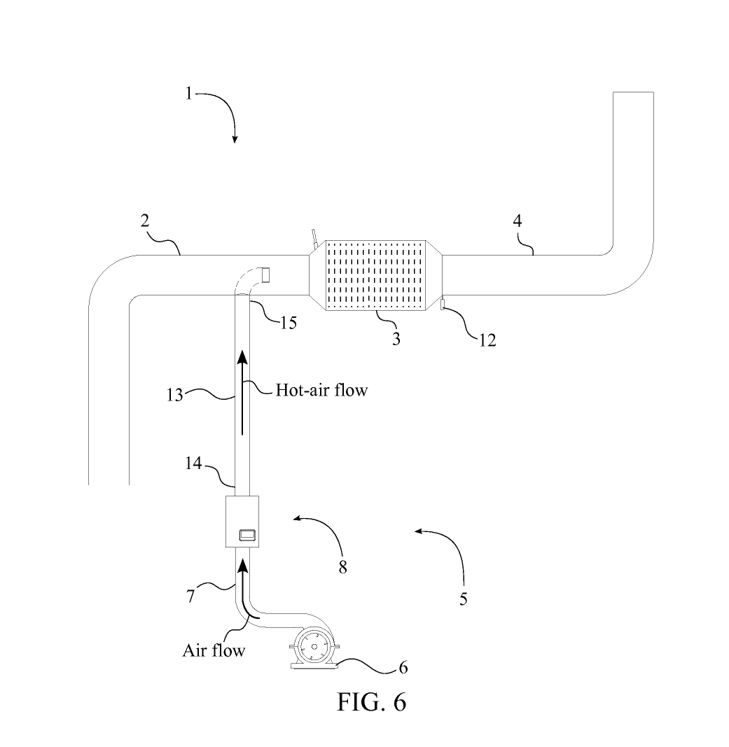

In reference to FIG. 5 that illustrates the overall method of the present invention, the thermostat 11 first measures an initial temperature of the SCR device 3. Since the thermostat 11 and the at least one temperature sensor 12 are electrically connected to each other, the thermostat 11 is able to retrieve the initial temperature of the SCR device 3 through the at least one temperature sensor 12. If the initial temperature of the SCR device 3 is lower than the desired temperature of the SCR device 3, which is set by the user within the thermostat 11, the thermostat 11 then activates the air blower 6 and the heating element 10 in order to generate the hot-air flow as shown in FIG. 6. The hot-air flow increases the temperature of the catalysts in order to bring the temperature of the catalysts up to the desired temperature, which may be at the activation temperature or may be at a slightly lower than the activation temperature if the user has concerns about the energy consumption of the pre-heat system. The activation temperature is the minimum temperature requirement for the efficient functionality of the SCR device 3. Then the hot-air flow is supplied into the inlet duct 2 through the heat supply pipe 13 so that the hot-air flow can travel through the catalyst. As a result, the hot-air flow is able to increase the initial temperature of the SCR device 3 to enable it to reach the activation temperature more quickly than if the SCR device 3 is only heated by the unpurified exhaust-gas flow from the upstream combustion device travelling in inlet duct 2. During this process, the thermostat 11 continuously monitors a current temperature of the SCR device 3 through the at least one temperature sensor 12 until the current temperature reaches up to the desired temperature. Then thermostat 11 automatically deactivates the air blower 6 so that the unpurified exhaust-gas flow from the inlet duct 2 can be released. Once the activation temperature of the SCR device 3 is reached, the unpurified exhaust-gas flow from the inlet duct 2 is converted by the SCR device 3 to a purified exhaust-gas flow that exits through outlet duct 4.

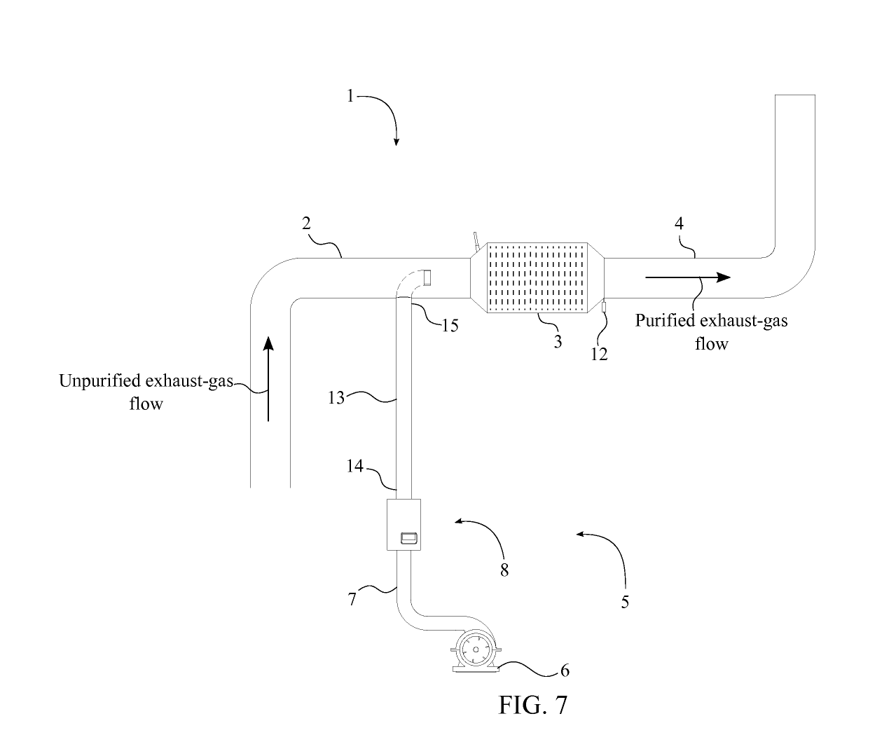

In reference to FIG. 7, once the current temperature of the SCR device 3 is equal to or greater than the activation temperature, then the unpurified exhaust-gas flow which is discharged by the combustion device through the inlet duct 2 can be purified. The discharging process of the unpurified exhaust-gas flow can be directly or indirectly implemented by the thermostat 11 once the activation temperature is detected within the SCR device 3. For example, the thermostat 11 can automatically start the boiler, the generator, or the reciprocating engine in order to discharge the unpurified exhaust-gas flow as the thermostat 11 electrically connects with a starter unit of the boiler, the generator, or the reciprocating engine. Additionally, the thermostat 11 can also function as an indicating device so that the boiler, the generator, or the reciprocating engine can be manually started by the respective operators at any time even if the thermostat 11 does not reach its preset temperature.

In one embodiment of the invention, when the unpurified exhaust-gas flow is discharged into the inlet duct 2, the thermostat 11 deactivates the air blower 6 and the heating element 10 as the catalyst no longer requires the hot-air flow from the pre-heat system 5. This is mainly due to the fact that the elevated temperature of the unpurified exhaust-gas flow is sufficient enough to maintain the activation temperature. Then the SCR device 3 is able to efficiently convert the unpurified exhaust-gas flow into the purified exhaust-gas flow by eliminating the NOₓ. Since the catalyst of the SCR device 3 is at the activation temperature when the unpurified exhaust-gas flow is discharged into the exhaust system 1, the SCR device 3 is able to maximize its functionality without any lag time. Then the purified exhaust-gas flow can be safely released into the atmosphere through the outlet duct 4.

In another embodiment of the invention, when the unpurified exhaust-gas flow is discharged into the inlet duct 2, the thermostat 11 modulates the air blower 6 and the heating element 10 to provide supplementary heat if the temperature of the unpurified exhaust-gas flow is not sufficient enough to maintain the activation temperature. Then the SCR device 3 is able to efficiently convert the unpurified exhaust-gas flow into the purified exhaust-gas flow by eliminating the NOₓ. Since the catalyst of the SCR device 3 is at the activation temperature when the unpurified exhaust-gas flow is discharged into the exhaust system 1, the SCR device 3 is able to maximize its functionality without any lag time. Then the purified exhaust-gas flow can be safely released into the atmosphere through the outlet duct 4.

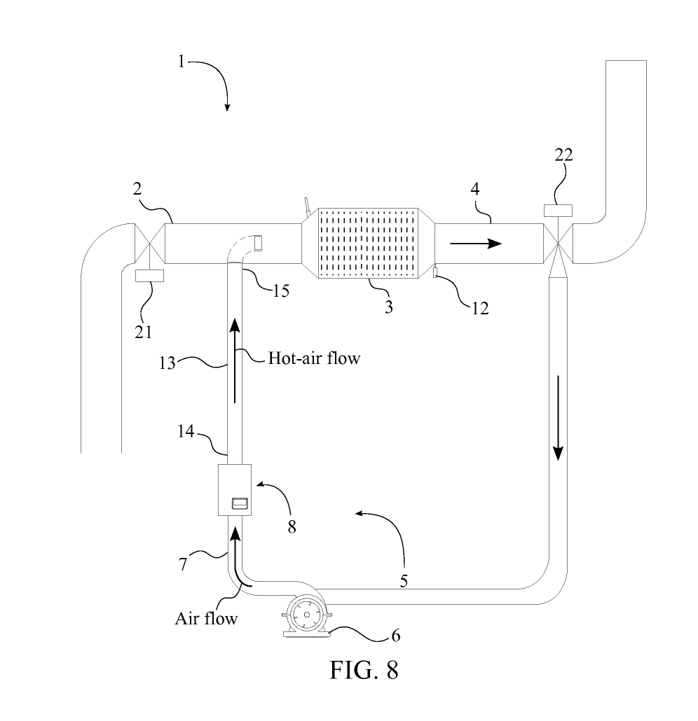

In reference to FIG. 8, the inlet duct 2 and the outlet duct 4 of the exhaust system 1 may optionally comprise a first damper valve 21 and a second damper valve 22 respectively. The first damper valve 21 is positioned within the inlet duct 2, upstream of the second end 15 of the heat supply pipe 13 and adjacent to the SCR device 3 while the second damper valve 22 is positioned within the outlet duct 4 and adjacent to the SCR device 3. The first damper valve 21 and the second damper valve 22 are controlled by the thermostat 11 as the first damper valve 21 and the second damper valve 22 are electrically connected with the thermostat 11. More specifically, when the pre-heat system 5 is activated within the exhaust system 1, the first damper valve 21 and the second damper valve 22 are at the closed-position so that the hot-air flow continuously circulates through the SCR device 3 and back into the pre-heat system 5. Then the catalyst can quickly reach the activation temperature with minimum power consumption by the air blower 6 and the heating element 10. However, when the unpurified exhaust-gas flow is discharged into the inlet duct 2, the first damper valve 21 and the second damper valve 22 are switched into the opened-position so that the unpurified exhaust-gas flow can be discharged into the SCR device 3 and the purified exhaust-gas flow can be discharged into the atmosphere.

Although the invention has been explained in relation to its preferred embodiment, it is to be understood that many other possible modifications and variations can be made without departing from the spirit and scope of the invention as hereinafter claimed.

What is claimed is:

1. A pre-heat system for catalysts of the selective catalytic reduction device comprises:
an air blower;
an interconnecting pipe;
a heater unit;
a heat supply pipe;
the heater unit comprises a housing, a heating element, a thermostat, and at least one temperature sensor;
the heater unit being in fluid communication with the air blower through the interconnecting pipe; and
the heater unit being in fluid communication with an exhaust system through the heat supply pipe opposite of the air blower.

2. The pre-heat system for catalysts of the selective catalytic reduction device as claimed in claim 1 comprises:
the interconnecting pipe being positioned in between the air blower and the heater unit.

3. The pre-heat system for catalysts of the selective catalytic reduction device as claimed in claim 1 comprises:
the heating element being internally positioned with the housing;
the thermostat being externally positioned with the housing; and
the interconnecting pipe and a first end of the heat supply pipe traversing into the housing.

4. The pre-heat system for catalysts of the selective catalytic reduction device as claimed in claim 1 comprises:
the air blower and the heating element being electrically connected with the thermostat; and
the at least one temperature sensor being electrically connected with the thermostat.

5. The pre-heat system for catalysts of the selective catalytic reduction device as claimed in claim 1 comprises:
the exhaust system comprises an inlet duct, a selective catalytic reduction (SCR) device, and an outlet duct;
the inlet duct being in fluid communication with the SCR device;
the outlet duct being in fluid communication with the SCR device opposite of the inlet duct;
a second end of the heat supply pipe being in fluid communication with the inlet duct and positioned adjacent to the SCR device; and
the at least one temperature sensor traversing into the outlet duct and being positioned adjacent to the SCR device.

6. A pre-heat system for catalysts of the selective catalytic reduction device comprises:
an air blower;
an interconnecting pipe;
a heater unit;
a heat supply pipe;
the heater unit comprises a housing, a heating element, a thermostat, and at least one temperature sensor;
the heater unit being in fluid communication with the air blower through the interconnecting pipe;
the heating element being internally positioned with the housing;
the thermostat being externally positioned with the housing;
the interconnecting pipe and a first end of the heat supply pipe traversing into the housing; and
the heater unit being in fluid communication with an exhaust system through the heat supply pipe opposite of the air blower.

7. The pre-heat system for catalysts of the selective catalytic reduction device as claimed in claim 6 comprises:
the interconnecting pipe being positioned in between the air blower and the heater unit.

8. The pre-heat system for catalysts of the selective catalytic reduction device as claimed in claim 6 comprises:
the air blower and the heating element being electrically connected with the thermostat; and
the at least one temperature sensor being electrically connected with the thermostat.

9. The pre-heat system for catalysts of the selective catalytic reduction device as claimed in claim 6 comprises:
the exhaust system comprises an inlet duct, a selective catalytic reduction (SCR) device, and an outlet duct;
the inlet duct being in fluid communication with the SCR device;
the outlet duct being in fluid communication with the SCR device opposite of the inlet duct;
a second end of the heat supply pipe being in fluid communication with the inlet duct and positioned adjacent to the SCR device; and
the at least one temperature sensor traversing into the outlet duct and being positioned adjacent to the SCR device.

10. A pre-heat system for catalysts of the selective catalytic reduction device comprises:
an air blower;
an interconnecting pipe;
a heater unit;
a heat supply pipe;
the heater unit comprises a housing, a heating element, a thermostat, and at least one temperature sensor;
the heater unit being in fluid communication with the air blower through the interconnecting pipe;
the heating element being internally positioned with the housing;
the thermostat being externally positioned with the housing;
the interconnecting pipe and a first end of the heat supply pipe traversing into the housing;
the heater unit being in fluid communication with an exhaust system through the heat supply pipe opposite of the air blower;
the air blower and the heating element being electrically connected with the thermostat; and
the at least one temperature sensor being electrically connected with the thermostat.

11. The pre-heat system for catalysts of the selective catalytic reduction device as claimed in claim 10 comprises:
the interconnecting pipe being positioned in between the air blower and the heater unit.

12. The pre-heat system for catalysts of the selective catalytic reduction device as claimed in claim 10 comprises:
the exhaust system comprises an inlet duct, a selective catalytic reduction (SCR) device, and an outlet duct;
the inlet duct being in fluid communication with the SCR device;
the outlet duct being in fluid communication with the SCR device opposite of the inlet duct;
a second end of the heat supply pipe being in fluid communication with the inlet duct and positioned adjacent to the SCR device; and
the at least one temperature sensor traversing into the outlet duct and being positioned adjacent to the SCR device.
